(19) United States
(12) Patent Application Publication
(10) Pub. No.: US 2010/0153970 A1
(43) Pub. Date: Jun. 17, 2010

(54) METHOD, APPARATUS AND COMPUTER PROGRAM PRODUCT FOR PROVIDING MULTI-DIMENSIONAL MANIPULATIONS TO CONTEXT MODELS

(75) Inventor: Sailesh Kumar Sathish, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/639,124

(22) Filed: Dec. 16, 2009

Related U.S. Application Data
(60) Provisional application No. 61/122,918, filed on Dec. 16, 2008.

(51) Int. Cl. G06F 9/54; G06F 9/44

(52) U.S. Cl. 719/316; 719/318

(57) ABSTRACT

An apparatus for providing multi-dimensional manipulations to context models may include a processor. The processor may be configured to generate a context model including an object representation for objects stored in one or more devices, enable provision of a context value to a calling application via a value interface, and provide an extension to the value interface to enable multiple context values to be associated with each object. A corresponding method and computer program product are also provided.

### CROSS REFERENCE TO RELATED APPLICATION

The present application claims priority to U.S. Provisional Patent Application No. 61/122,918, filed Dec. 16, 2008, the contents of which are incorporated by reference herein.

### TECHNOLOGICAL FIELD

Embodiments of the present invention relate generally to communication interface technology and, more particularly, relate to a method, apparatus, and computer program product for providing multi-dimensional manipulations to context models.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In some situations, it may be desirable for an application (e.g., a web based application) to have the ability to access information or objects from a device providing information to the application. For example, context data including device data related to capabilities, current operating state and/or other device data that may be static and/or dynamic may be useful information for the application to access. In this regard, context data may be associated with content stored on a device in order to provide information which might assist in identifying data of interest. Context data is data that characterizes a particular situation at any point in time and may be either static or dynamic. Thus, for example, context data may represent device, system and environment data. The context data may be used by applications for different purposes, such as generating metadata or performing an adaptation based on the context. A context model is a mechanism by which organized or unorganized forms of context data can be exposed to a calling application. Meanwhile, a provider typically provides data to the context model. Usually, a context model exposes a fixed set of application programming interfaces (APIs) to applications that reflect the underlying nature of the context model itself.

There are several context models available to provide context data. The context models available may have different architectures and various applications may be developed for use with specific ones of the different architectures. The applications may be able to change their behavior (e.g., via dynamic adaptations) based on changing context data. In general, the context models may be considered to be either data based models or object based models. In data based models, data is available without consideration of who provided the data. Calling applications may query the system for a particular type of data to determine whether such data is available. However, in object based models, each provider of data has an object representation and the object can be queried in order to get current updated data. The APIs provide access to the object based model through which the current state of the object (e.g., the context data) can be queried. Object based model related systems are considered to be more organized and may be more likely to be deployed in mobile environments due to a lower cost of infrastructure, maintenance, manageability and efficiency.

Delivery Context Client Interface (DCCI) is a mechanism through which applications can access device data such as delivery context information using, for example, a Document Object Model (DOM) like interface. As such, DCCI may act as a consumer interface for web applications (consumers) and providers of data to a tree-like interface. Providers of data can be any static or dynamic sources providing information such as device location, device orientation, screen brightness, battery strength, and many others.

One current limitation of object based models is that in such models each object representation represents only one data item. Thus, object based models may tend to be relatively data centric since there may only be one dynamic data item being exposed. As such, if a data provider provided multiple types of data (related or not), the provider may have an object representation for each type of data that is exposed, which may increase the complexity of the model through representation of multiple objects pertaining to each provider.

Accordingly, it may be desirable to provide a framework for overcoming at least some of the disadvantages discussed above.

### BRIEF SUMMARY

A method, apparatus and computer program product are therefore provided for a context model providing multi-dimensional data spaces for objects along with manipulation functions. In particular, a method, apparatus and computer program product are provided that create a mechanism providing multi-dimensional manipulations to context models in environments such as, for example, smart environments.

Embodiments of the invention may provide a method, apparatus and computer program product for employment in a web based, or other network based operating environment. As a result, for example, device users may enjoy improved capabilities with respect to applications and services accessible via the device.

In one embodiment, a method is provided that includes generating a context model including an object representation for objects stored in one or more devices. The method may also include enabling provision of a context value to a calling application via a value interface. Further, the method of this embodiment may include providing an extension to the value interface to enable multiple context values to be associated with each object.

In another embodiment, a computer program product is provided that includes at least one computer-readable storage medium having computer-executable program code instructions stored therein. The computer-executable program code instructions of this embodiment include program code instructions for generating a context model including an object representation for objects stored in one or more devices. The program code instructions also include program code instructions for enabling provision of a context value to a calling application via a value interface. Further, the program code instructions include program code instructions for providing an extension to the value interface to enable multiple context values to be associated with each object.

In a further embodiment, an apparatus is provided that includes at least one processor and at least one memory including computer program code. The at least one memory and the computer program code are configured to, with the at least one processor, to cause the apparatus to generate a context model including an object representation for objects stored in one or more devices. The apparatus is also configured to enable provision of a context value to a calling application via a value interface and to provide an extension to the value interface to enable multiple context values to be associated with each object.

In yet another embodiment, an apparatus is provided that includes means for generating a context model including an object representation for objects stored in one or more devices. The apparatus of this embodiment also induces means for enabling provision of a context value to a calling application via a value interface and means for providing an extension to the value interface to enable multiple context values to be associated with each object.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a system showing an example of a communication environment according to an exemplary embodiment of the present invention;

FIG. 2 is a schematic block diagram of an apparatus for providing multi-dimensional manipulations to a context model according to an exemplary embodiment of the present invention; and

FIG. 3 is a block diagram according to an exemplary method for providing multi-dimensional manipulations to a context model according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Electronic devices have been rapidly developing in relation to their communication capabilities. As the capabilities of such devices have increased, applications that are sensitive to the capabilities of the devices have also been developed. Thus, for example, applications that are sensitive to the current operating state or context of devices have been developed. The devices are often able to determine, keep and communicate information about their own current operating state. For example, battery level, available bandwidth, certain device settings, hardware and software capabilities, local ambient light level and many other state related pieces of information may be determined and/or communicated to other devices. In order to communicate information on device operating state to various applications such as, for example, an application associated with accessing the web, an interface may be provided. An example of such an interface is Delivery Context Client Interface (DCCI), which is a World Wide Web Consortium (W3C) specification. DCCI may enable context information, which may be referred to as delivery context information, to be made available to scripts running in web pages within a browser on a device.

Context is generally defined as any information that can be used to characterize the situation of an entity. Context parameters may include parameters related to, for example, environmental context, social context, spatio-temporal context, task context, personal context, terminal context, service context, access context, and/or the like. Delivery context may be used to describe a set of characteristics of a device, a network, user preferences and other aspects that may apply to an interaction between the device and an application (e.g., a web application). Aspects of delivery context could be either static or dynamic. Static aspects may include color resolution, display size, keyboard arrangement or other fixed properties of the device. Dynamic aspects may include properties of the device that may change over time such as current battery level, device orientation, device location, other applications running, and numerous other like characteristics.

DCCI may be a mechanism through which applications can access delivery context information using, for example, a Document Object Model (DOM) (which is also a W3C specification) like interface. Accordingly, applications can register event listeners on property nodes that initiate events based on property or other changes. In this regard, DCCI provides interfaces for applications that utilize delivery context information. DCCI provides a tree-like representation of context data on a device that can be represented in a hierarchical manner conforming to some standard ontology; e.g., Delivery Context Ontology (DCO).

Because of inherent relationships that context information may represent, context information may be represented as a tree structure. The tree structure may represent a hierarchical relationship between different context properties in which each property may form a node in the tree structure. DCCI is one example of such a tree structure, but it should be understood that embodiments of the present invention extend beyond this one example and may be extended to many other data structures that specify relationships between data objects and/or how they can be effectively distributed and shared.

Context may be determined, for example, based on a determination of various context parameters. DCCI uses context information to enable adaptation that permits interaction with various applications while considering device context. In some cases, when devices are brought in proximity to each other in certain networks, such as smart spaces, context information, e.g. information regarding device capabilities, may desirably be shared between such devices so that each device can receive some information about the capabilities of the other device. Some embodiments of the present invention provide a mechanism by which multi-dimensional data spaces may be provided for each object represented. Additionally, some embodiments provide manipulation functions corresponding to the multi-dimensional spaces provided. Although embodiments will be described below in the context of a DCCI related environment, it should be understood that embodiments may also relate to other object based model environments.

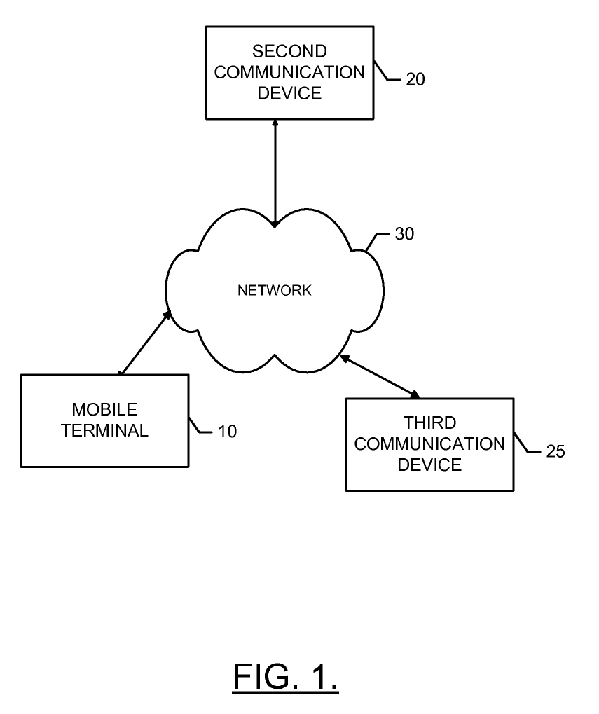

FIG. 1 illustrates a generic system diagram in which a device such as a mobile terminal 10 is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a P2P network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, Wireless LAN (WLAN), Worldwide Interoperability for Microwave Access (WiMAX), WiFi, Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a context model to assist in providing an interface between applications and providers. As such, for example, a consumer application may request information from a provider within the network 30 and any one of the mobile terminal 10 or the second and third communication devices 20 and 25 may host a consumer application while any other one of the mobile terminal 10 or the second and third communication devices 20 and 25 acts as a provider with respect to the consumer application to provide information such as delivery context information to the respective consumer application. The context model may be an object based model in which each provider has an object representation in the model. Thus, the context model may provide consumer applications with access to context data such as dynamic data.

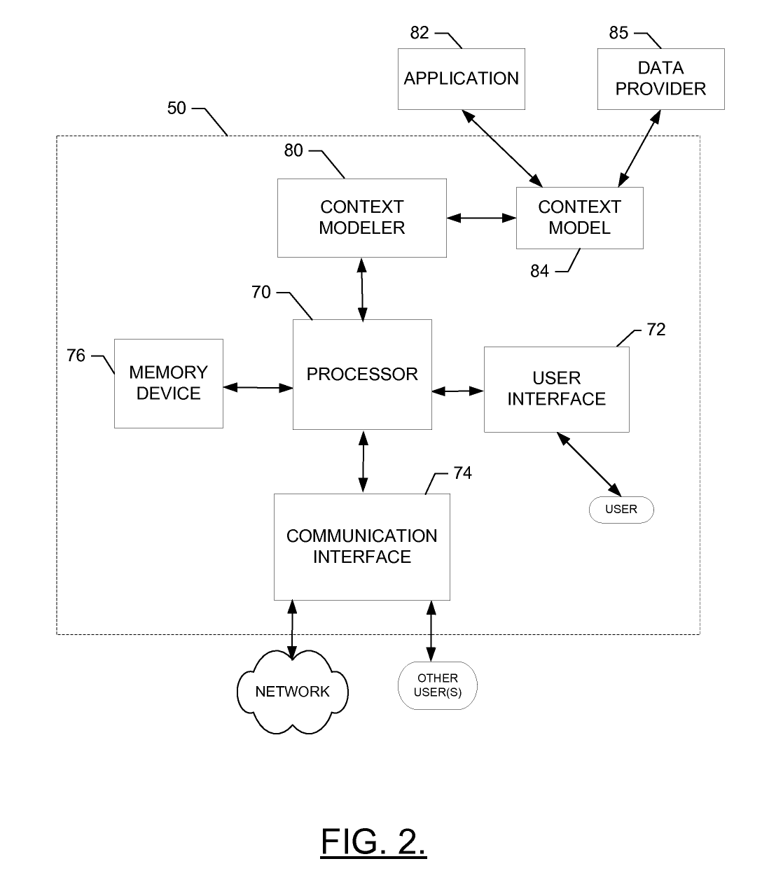

FIG. 2 illustrates a schematic block diagram of an apparatus for enabling the provision of multi-dimensional manipulations to a context model according to an exemplary embodiment of the present invention. An exemplary embodiment of the invention will now be described with reference to FIG. 2, in which certain elements of an apparatus 50 for providing multi-dimensional manipulations to a context model are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus 50 for providing multi-dimensional manipulations to a context model is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity capable of performing operations according to embodiments of the present invention while configured accordingly.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, remotely located, or eliminated.

In an exemplary embodiment, the processor 70 may be embodied as, include or otherwise control a context modeler 80. The context modeler 80 may be any means such as a device or circuitry embodied in hardware, software or a combination of hardware and software (e.g., processor 70 operating under software control, the processor 70 embodied as an ASIC or FPGA specifically configured to perform the operations described herein, or a combination thereof) that is configured to perform the corresponding functions of the context modeler 80 as described below. In this regard, for example, the context modeler 80 may be configured to provide, among other things, for the generation of a context model and for the provision of multi-dimensional manipulations to the context model. As such, the context modeler 80 may develop a context model 84 that may be used to provide a model representation of objects so that information regarding context of the various objects may be provided to calling applications.

In some embodiments, the context modeler 80 may be in communication with one or more applications (e.g., application 82) that may act as consumers with respect to device context information provided (e.g., via DCCI). Application 82 may be a web application or some other network application for which information about properties associated with the apparatus 50 of FIG. 2 may be useful. As such, in some cases, the application 82 may be in communication with the context modeler 80 via the communication interface 74 (and/or via the processor 70). In an exemplary embodiment, the context model 84 may serve as a communication interface between data providers (e.g., data provider 85) and the application 82. The data provider 85 could be either a local provider or a remote provider, which may act as a source of data. The data provider 82, like the application 82, may be in direct communication with the context modeler 80 (and/or the context model 84), or may establish such communication via the communication interface 74 or the processor 70.

In an exemplary embodiment, the context modeler 80 may be embodied in software as instructions that are stored in the memory of a communication device (e.g., the mobile terminal 10 and/or the second and third communication devices 20 and 25) and executed by the processor 70. Alternatively, the context modeler 80 may be embodied as software that forms a part of or is installed on middleware, for example, of the communication device. As another alternative, the context modeler 80 may be embodied as the processor 70 (e.g., as an FPGA, ASIC, or the like). The context modeler 80 may be configured to develop a context model (e.g., context model 84) including a model representation of multiple (in some cases all) devices in communication with the communication device (e.g., the mobile terminal 10 and/or the second and third communication devices 20 and 25). Accordingly, when, for example, a communication session is established between the mobile terminal 10 and the second communication device 20 and/or the third communication device 25, the context modeler 80 may be configured to determine a model representation of the second and/or third communication devices 20 and 25 with respect to the content and characteristics of each corresponding device. As such, for example, if the second communication device 20 is a mobile telephone, the context model may include capabilities and other characteristics of the mobile telephone. The context model may include an object registry (e.g., object model) including an object representation of each corresponding object stored in the corresponding device. Accordingly, for each object created at the corresponding device, information about the characteristics, capabilities, data structure, manufacturer, version number, and other like information may be determined by the context modeler 80. In an exemplary embodiment, when an application (e.g., application 82) uses or requests context data, the context modeler 80 is configured to be capable of utilizing the context model 84 to provide a context value through a value interface associated with the context modeler 80.

However, the context modeler 80 according to some embodiments is further configured to provide multi-dimensional data spaces for each object along with corresponding manipulation functions as described in greater detail below. As such, the context modeler 80 according to some embodiments of the present invention may provide for objects to expose values through an interface. Moreover, the interface may be extended to provide more than just one value. However, in some embodiments, a field may present such values instead of an interface.

The interface (or field) in the context model 84 may be defined to be of “any” type such as string, int, double, XML, text, etc. Accordingly, the context modeler 80 may be configured to provide an ability to extend each object representation to represent multiple (and/or all) values that a corresponding provider can expose. In this regard, the context modeler 80 may be configured to utilize a single namespace for an object spanning all values (even though each value type may have its own namespace) corresponding to the object. In an example embodiment, the interface may be as follows:

Interface Value{
Int valueNos;
Interface indValue{
Readonly attribute DomString valueName;
Typeany value;
Readonly attribute DomString valueType;
Optional readonly attribute DomString namespaceURI;
Typeany interface metadataInterface;
Typeany relationExpressions;
};
.........
};

The interface lists the number of values that correspond to a particular object in the interface through the valueNos attribute.

In an exemplary embodiment, each value may be a structure of its own called indValue (individual interface). The attribute valueName indicates the name of this value. The “value” attribute is the current value. The valueType string indicates the type of value of a particular value so that calling applications can accurately interpret the type associated with the particular value. The namespaceURI lists any namespaces that may be applicable to a corresponding value type. In some embodiments, an optional metadata interface provides all metadata features of a particular value type. The relationExpression attribute provides relations that the particular value may have with other values exposed by the same object. Many different expressions are possible. Each interface can have “n” number of values. Thus it is possible to have one object expose multiple values that can be mutually exclusive or not. Furthermore, it should be noted that the interface need not have the specific structure defined above, so long as the corresponding functionalities are provided.

Given that the context modeler 80 provides for the possibility of associating a plurality of values with a single object, the context modeler 80 may further enable search operations along multiple dimensions. In this regard, one exemplary benefit of the context model 84 generated by the context modeler 80 of embodiments of the present invention not only comes from the ability of the context model 84 to accommodate a range of property values, but also in the powerful search mechanisms provided by the context modeler 80. For example, the context modeler 80 may enable searching along multiple dimensions while keeping one or more values constant or within a certain range.

In some embodiments, the context modeler 80 may provide yet further additional interfaces to extend the context model (e.g., DCCI) interfaces to support multi-dimensional models. For example, the context modeler 80 may provide for use of a “get” value along multiple dimensions. In this regard, for example, int getValue (in Struct valueStruct, out Struct value, in Boolean persistence) may extend the context model interfaces. The getValue call may return a value indicating whether or not a getValue call was a success and, if not, provide a cause of failure. According to some embodiments, the getValue call takes in a structure valueStruct that lists a set of parameters to satisfy criterion for successful selection of a value and the out parameter value that lists the selected value and its metadata associations. The valueStruct may then enable an application to list certain criterion to be satisfied before the value is returned in the struct value. The persistence Boolean value determines whether to wait for the criterion to get satisfied or return a response immediately.

The struct valueStruct lists the name of the value and a list of criterion that can be logical or mathematical expressions combined with names of other values in the same object. If a current value (or set of values pertaining to an object or multiple objects) pertaining to the name of the value satisfies the expressions listed, then the current value along with its associated metadata may be put into the out Struct “value”. The expression evaluation (search criterion) carried out over sets of objects may return a Boolean value determinative of whether a value and associated metadata can be included within an out struct or not. If the persistence Boolean value is set to “True”, then the getValue call may become a blocking call that waits for the criterion to be satisfied before returning. This may be useful, for example, in connection with “While” expressions.

Another interface extension the context modeler 80 may provide includes the addition of an event listener (e.g., a device configured to perform a particular function in response to the occurrence of a particular event) along multiple dimensions. In this regard, the context modeler 80 may provide a mechanism for evaluation of an expression to determine whether to add an event listener to a node. The expression can be evaluated against all nodes having multiple values to determine whether the same event listener can be added. Accordingly, it may be possible to have the same event listener added at multiple nodes.

As an example, the interface EventTarget may be extended (or addEventListener is overridden) with a call: Void addEventListener (in DOMString type, in Eventlistener listener, in Boolean useCapture, in Boolean persistence, in Struct listenerCriterion). The listener criterion struct provides expressions that can be evaluated across one or more values within an object or across multiple objects addressed, e.g., via XPath expressions. The Boolean persistence allows the non-blocking of addEventListener so that the first successful evaluation of addEventListener may be executed before providing a return in response to a call. In some cases, the addEventListener call may be executed at or near the top of the tree. In other words, the addEventListener call may be the root node.

In some embodiments, the context modeler 80 may further provide support for searching along multiple dimensions (e.g., for all values that are affected). The search feature may extend current search mechanisms by providing powerful handles for searching across values along all objects within a system. The interface for search may be similar to the getValue except that the behavior may be different. In an exemplary embodiment, the extension provided in support of searching may include, for example, Int searchValue (in struct valueStruct, out Struct value, in Boolean persistence) In this regard, the valueStruct may include the name of the value (optional) in which a calling application is interested and/or the name of the data source or object (optional) in which the calling application is interested. If both the name of the value and the name of the data source or object are not specified, all current value names that satisfy the criterion mentioned in subsequent fields of valueStruct may be returned via the Struct value.

A difference between searching along multiple dimensions and the getValue is that, in getValue, only a specific object is queried. Meanwhile, in searchValue, the entire tree structure is queried along with all objects. The struct value is also different in relation to searching than the get operation in that the structure can also host object names in addition to value names where corresponding values have been found. The criterion mentioned in the fields of struct valueStruct can span value expressions within multiple objects versus the same object expression in getValue. In some cases, the addressing scheme employed for searching may be model dependent. In the example case of DCCI, the addressing scheme may employ modified XPath expressions. If Boolean persistence is employed, the function may wait until the first object/value that satisfies the criterion is obtained. The return value may function in similar fashion as in the getValue.

Thus, in certain scenarios, some embodiments of the present invention provide a mechanism by which a relatively low footprint may be maintained while increasing efficiency and reducing complexity of context models. Moreover, since future expansions and requirements mature, flexibility is provided with respect to providing information about dynamic sources of data. The framework provided by some exemplary embodiments also allows for a more intuitive and powerful search mechanism and also aid directed search and notifications along one or more dimensions of data.

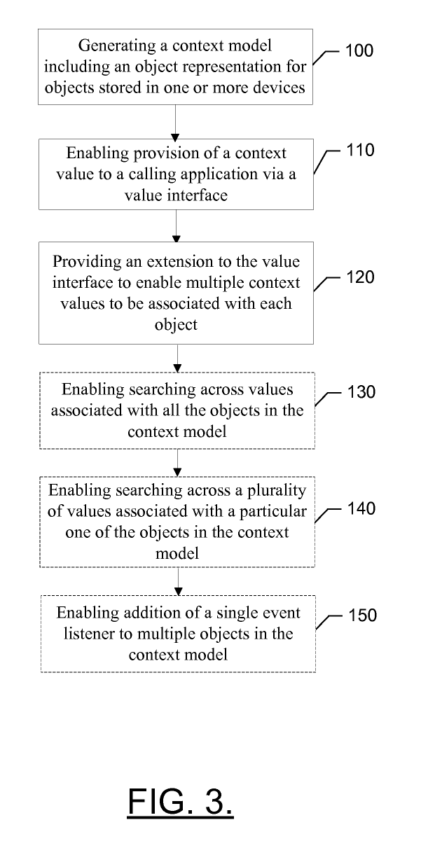

FIG. 3 is a flowchart of a system, method and program product according to exemplary embodiments of the invention. It will be understood that each block of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a built-in processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method for providing predictor nodes for context models as illustrated, for example, in FIG. 3 includes generating a context model (e.g., a DCCI model) including an object representation for objects stored in one or more devices at operation 100, enabling provision of a context value to a calling application via a value interface at operation 110, and providing an extension to the value interface to enable multiple context values to be associated with each object at operation 120.

In some embodiments, the method may include further optional operations, examples of which are shown in dashed lines in FIG. 3. Optional operations may be performed in any order and/or in combination with each other in various alternative embodiments. As such, the method may further include an operation of enabling searching across values associated with all the objects in the context model at operation 130. In some embodiments, the method may include enabling searching across a plurality of values associated with a particular one of the objects in the context model at operation 140. Additionally or alternatively, the method may include enabling addition of a single event listener to multiple objects in the context model at operation 150.

In some embodiments, certain ones of the operations above may be modified or further amplified as described below. It should be appreciated that each of the modifications or amplifications below may be included with the operations above either alone or in combination with any others among the features described herein. In this regard, for example, enabling the addition of the single event listener to multiple objects in the context model may include providing assignment of the single event listener to objects that satisfy provided criteria. In some cases, providing the extension may include, for a particular object, utilizing a single namespace for the particular object in which the single namespace spans a plurality of property values.

In an exemplary embodiment, an apparatus for performing the method of FIG. 3 above may comprise a processor (e.g., the processor 70) configured to perform some or each of the operations (100-150) described above. The processor may, for example, be configured to perform the operations (100-150) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-150 may comprise, for example, the processor 70, the context modeler 80, and/or an algorithm executed by the processor 70 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
generating a context model including an object representation for objects stored in one or more devices;
enabling provision of a context value to a calling application via a value interface; and
providing an extension to the value interface to enable multiple context values to be associated with each object.

2. The method of claim 1, further comprising enabling searching across values associated with all the objects in the context model.

3. The method of claim 1, further comprising enabling searching across a plurality of values associated with a particular one of the objects in the context model.

4. The method of claim 1, further comprising enabling addition of a single event listener to multiple objects in the context model.

5. The method of claim 4, wherein enabling the addition of the single event listener to multiple objects in the context model comprises providing assignment of the single event listener to objects that satisfy provided criteria.

6. The method of claim 1, wherein providing the extension comprises, for a particular object, utilizing a single namespace for the particular object in which the single namespace spans a plurality of property values.

7. The method of claim 1, wherein generating the context model comprises generating a delivery context client interface (DCCI) model.

8. A computer program product comprising at least one computer-readable storage medium having computer-executable program code instructions stored therein, the computer-executable program code instruction comprising:
program code instructions for generating a context model including an object representation for objects stored in one or more devices;
program code instructions for enabling provision of a context value to a calling application via a value interface; and
program code instructions for providing an extension to the value interface to enable multiple context values to be associated with each object.

9. The computer program product of claim 8, further comprising program code instructions for enabling searching across values associated with all the objects in the context model.

10. The computer program product of claim 8, further comprising program code instructions for enabling searching across a plurality of values associated with a particular one of the objects in the context model.

11. The computer program product of claim 8, further comprising program code instructions for enabling addition of a single event listener to multiple objects in the context model.

12. The computer program product of claim 11, wherein program code instructions for enabling the addition of the single event listener to multiple objects in the context model include instructions for providing assignment of the single event listener to objects that satisfy provided criteria.

13. The computer program product of claim 8, wherein program code instructions for providing the extension include instructions for, for a particular object, utilizing a single namespace for the particular object in which the single namespace spans a plurality of property values.

14. The computer program product of claim 8, wherein program code instructions for generating the context model include instructions for generating a delivery context client interface (DCCI) model.

15. An apparatus comprising at least one processor and at least one memory including computer program code, the at least one memory and the computer program code configured to, with the at least one processor, to cause the apparatus to perform at least the following:
generate a context model including an object representation for objects stored in one or more devices;
enable provision of a context value to a calling application via a value interface; and
provide an extension to the value interface to enable multiple context values to be associated with each object.

16. The apparatus of claim 15, wherein the at least one memory and the computer program code are configured, with the at least one processor, to cause the apparatus to enable searching across values associated with all the objects in the context model.

17. The apparatus of claim 15, wherein the at least one memory and the computer program code are configured, with the at least one processor, to cause the apparatus to enable searching across a plurality of values associated with a particular one of the objects in the context model.

18. The apparatus of claim 15, wherein the at least one memory and the computer program code are configured, with the at least one processor, to enable addition of a single event listener to multiple objects in the context model.

19. The apparatus of claim 18, wherein the at least one memory and the computer program code are configured, with the at least one processor, to enable the addition of the single event listener to multiple objects in the context model by providing assignment of the single event listener to objects that satisfy provided criteria.

20. The apparatus of claim 15, wherein the at least one memory and the computer program code are configured, with the at least one processor, to provide the extension by, for a particular object, utilizing a single namespace for the particular object in which the single namespace spans a plurality of property values.

21. The apparatus of claim 15, wherein the at least one memory and the computer program code are configured, with the at least one processor, to generate the context model by generating a delivery context client interface (DCCI) model.

22. An apparatus comprising:
means for generating a context model including an object representation for objects stored in one or more devices;
means for enabling provision of a context value to a calling application via a value interface; and
means for providing an extension to the value interface to enable multiple context values to be associated with each object.

23. The apparatus of claim 22, further comprising means for enabling searching across values associated with all the objects in the context model or across a plurality of values associated with a particular one of the objects in the context model.
